(19) United States
(12) Patent Application Publication
(10) Pub. No.: US 2020/0023989 A1
(43) Pub. Date: Jan. 23, 2020

(54) HYDROGEN AFTER BURNER

(71) Applicant: EVIATION TECH LTD, Kadima (IL)

(72) Inventors: Omer BAR YOHAI, Sdeh Itzhak (IL); Dekel TZIDON, Hod Hasharon (IL)

(73) Assignee: EVIATION TECH LTD, Kadima (IL)

(21) Appl. No.: 16/489,700

(22) PCT Filed: Feb. 28, 2018
(86) PCT No.: PCT/IL2018/050224

§ 371 Date: Aug. 29, 2019

Related U.S. Application Data
(60) Provisional application No. 62/465,182, filed on Mar. 1, 2017.

(51) Int. Cl. B64D 37/30; B64D 27/24; B64D 33/04; F02K 7/08

(52) U.S. Cl. CPC B64D 37/30; B64D 27/24; F05D 2240/35; F02K 7/08; F05D 2220/60; B64D 33/04

(57) ABSTRACT

Generally, a vehicle comprising at least one hydrogen releasing element is provided. The vehicle can include at least one hydrogen releasing element coupled to a body of the vehicle. The vehicle can include a hydrogen combustion region positioned adjacent to a predetermined portion of the vehicle body. The vehicle can include at least one ignition element positioned within the hydrogen combustion region that can inflame hydrogen within the hydrogen combustion region. The vehicle can include a housing surrounding the hydrogen combustion region. The housing can form combustion chamber thereby providing additional thrust to the vehicle. In some embodiments, the vehicle is an airborne vehicle.

### BACKGROUND OF THE INVENTION

Modern airborne vehicles are frequently powered by, for example, electric motors. The electric motors can receive electricity from a power source positioned on the airborne vehicle. The power source can include, for example, fuel cells. The fuel cells can, for example, consume or release hydrogen. Hydrogen can be highly combustible and/or can burn in free air at predetermined conditions (e.g., when a partial portion of hydrogen in free air is ranging between 4% and 75%).

### SUMMARY OF THE INVENTION

One aspect of the present invention provides a vehicle including: at least one hydrogen releasing element coupled to a body of the vehicle; a hydrogen combustion region positioned adjacent to a predetermined portion of the vehicle body; a conduit connecting the at least one hydrogen releasing element and the hydrogen combustion region, the conduit to deliver hydrogen released by the at least one hydrogen releasing element to the hydrogen combustion region; at least one ignition element positioned within the hydrogen combustion region, the at least one ignition element to inflame hydrogen within the hydrogen combustion region; and a controller to control the delivery of hydrogen through the conduit and to control the at least one ignition element.

Another aspect of the present invention provides an airborne vehicle including: at least one hydrogen releasing element coupled to a body of the airborne vehicle; a hydrogen combustion region positioned adjacent to a predetermined portion of the airborne vehicle body; a conduit connecting the at least one hydrogen releasing element and the hydrogen combustion region, the conduit to deliver hydrogen released by the at least one hydrogen releasing element to the hydrogen combustion region; at least one ignition element positioned within the hydrogen combustion region, the at least one ignition element to inflame hydrogen within the hydrogen combustion region; and a controller to control the delivery of hydrogen through the conduit and to control the at least one ignition element.

In some embodiments, the at least one hydrogen releasing element includes at least one of: a metal-air cell, an open-ended fuel cell or any combination thereof.

In some embodiments, hydrogen is released from the at least one hydrogen releasing element at a pressure of 1 atm.

In some embodiments, the airborne vehicle further includes a compressor positioned along the conduit, the compressor to pressurize hydrogen released by the at least one releasing element to a predetermined pressure value.

In some embodiments, the hydrogen combustion region comprises oxygen and wherein a partial portion of hydrogen within the hydrogen combustion region ranges between 4% and 75%.

In some embodiments, the predetermined portion of the airborne vehicle body includes a spinner of a propeller positioned at a rear portion of an engine of the airborne vehicle, and wherein the rear is with respect to a flight direction.

In some embodiments, hydrogen is pressurized within the hydrogen combustion region due to a rotational motion of the spinner.

In some embodiments, the controller further to determine a frequency of rotation of the spinner and to prevent the inflation of hydrogen within the hydrogen combustion region when the determined frequency is below a predetermined value of revolutions per minute (RPM).

In some embodiments, the airborne vehicle further includes a housing to surround the hydrogen combustion region, the housing having a first end and a second end, wherein the first end is positioned adjacent to the spinner.

In some embodiments, the housing having a tapered shape in a longitudinal direction along the housing, and wherein a diameter of the first end is greater than a diameter of the second end.

In some embodiments, the airborne vehicle further includes a second conduit to deliver oxygen into the hydrogen combustion region such that a partial portion of hydrogen within the hydrogen combustion region ranges between 4% and 75%.

In some embodiments, the ignition element includes ignition wires introduced into the hydrogen combustion region through at least one of: a shaft of the propeller, a substantially hollow shaft of the engine, a shaft of the propeller, a shaft of the spinner or any combination thereof.

In some embodiments, an ignition spark is generated within the hydrogen combustion region due to electrostatic effect induced by at least one of: a rotational motion of the spinner relative to a shaft of the propeller, a rotational motion of the spinner relative to the housing or any combination thereof.

In some embodiments, the housing includes at least one opening positioned at the second end of the housing, the at least one opening to enable escaping of burning products from the housing thereby providing additional thrust to the airborne vehicle.

In some embodiments, the engine is an electric engine and wherein the conduit is introduced through a substantially hollow shaft of the engine.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of an airborne vehicle including at least one hydrogen releasing element and/or adapted for a controlled reduction of hydrogen, according to some embodiments of the invention; and

FIG. 2 is a schematic illustration of an airborne vehicle including at least one hydrogen releasing element and/or adapted for increasing a thrust by a controlled combustion of hydrogen, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Generally, a vehicle comprising at least one hydrogen releasing element and/or adapted for a controlled reduction of hydrogen is provided. The vehicle can include at least one hydrogen releasing element coupled to a body of the vehicle. The vehicle can include a hydrogen combustion region positioned adjacent to a predetermined portion of the vehicle body. The vehicle can include a conduit connecting the at least one hydrogen releasing element and the hydrogen combustion region. The conduit can deliver hydrogen released by the at least one hydrogen releasing element to the hydrogen combustion region. The vehicle can include at least one ignition element positioned within the hydrogen combustion region. The at least one ignition element can inflame hydrogen within the hydrogen combustion region. The vehicle can include a controller that can control the delivery of hydrogen through the conduit and to control the at least one ignition element. The vehicle can include a housing surrounding the hydrogen combustion region. The housing can include at least one opening to enable escaping of burning products from the housing thereby providing additional thrust to the vehicle.

In some embodiments, the vehicle is an airborne vehicle. It is noted that the following description exemplifies the vehicle as an airborne vehicle. As may be apparent to one of ordinary skill in the art, the vehicle may be of various types, for example, an amphibious vehicle and/or a land vehicle.

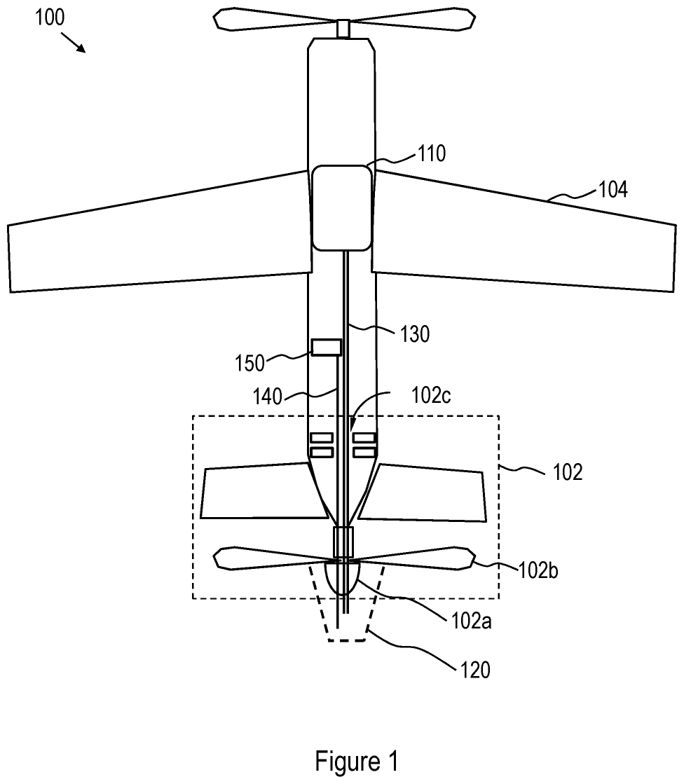

Reference is now made to FIG. 1, which schematically illustrates an airborne vehicle 100 including at least one hydrogen releasing element 110 and/or adapted for a controlled reduction of hydrogen, according to some embodiments of the invention. In various embodiments, the at least one hydrogen releasing element 110 includes a hydrogen tank and/or a metal-air cell and/or open-ended or close-ended fuel cell.

Airborne vehicle 100 can include a hydrogen combustion region (HCR) 120. The HCR 120 can be positioned external and/or adjacent to a predetermined portion of the airborne vehicle 100. For example, HCR 120 can be positioned adjacent to spinner 102a of propeller 102b at a rear portion of engine 102 of airborne vehicle 100, where ‘rear’ is with respect to a flight direction of vehicle 100. In some embodiments, HCR 120 includes oxygen, for example, oxygen that is in the air surrounding HCR 120.

In some embodiments, engine 102 is an electric engine. As may be apparent to one of ordinary skill in the art, while FIG. 1 illustrates engine 102 as being positioned at the rear portion of the airborne vehicle 100, it is not meant to be limiting in anyway and engine 102 can be positioned at various portions of the airborne vehicle 100, for example, at wings 104.

Airborne vehicle 100 can include conduit 130 that can connect the at least one hydrogen releasing element 110 and HCR 120. Airborne vehicle 100 can include a pump (not shown) to deliver or urge hydrogen released by the at least one hydrogen releasing element 110 to HCR 120 through conduit 130. Conduit 130 can include, for example, valves (not shown) to allow a controllable flow of the hydrogen through conduit 130. In various embodiments, conduit 130 is embedded within the body of airborne vehicle 100 and/or passes through, for example, hollow shaft 102c of engine 102 (e.g., as shown in FIG. 1). In some embodiments, at least a portion of the conduit 130 is poisoned external of the body of airborne vehicle 100 (not shown).

The at least one hydrogen releasing element 110 can release hydrogen at a pressure ranging between 0.9 and 1.1 atm. Airborne vehicle 100 can include a compressor (not shown) that can pressurize hydrogen released by the at least one hydrogen releasing element 110 to a predetermined pressure value. In various embodiments, pressurizing hydrogen (e.g., by the compressor) can enable delivering hydrogen released by the at least one releasing element 110 to HCR 120 and/or can enable increasing a concentration (e.g., a partial portion) of hydrogen within HCR 120 to a predetermined value. The compressor can be positioned, for example, along conduit 130. In some embodiments, hydrogen is pressurized within the HCR 120 due to a rotational motion of spinner 102a of propeller 102b.

Airborne vehicle 100 can include at least one ignition element 140 that can be positioned within the HCR 120. The at least one ignition element 140 can inflame the hydrogen within the HCR 140 by, for example, generating an ignition spark. The at least one ignition element can include ignition wires that can be introduced into the HCR 120 through, for example, the hollow shaft 102c of engine 102 and/or through a shaft of the spinner 102a and/or propeller 102b.

Airborne vehicle 100 can include controller 150. Controller 150 can control the delivery of hydrogen from the at least one hydrogen releasing element 110 to HCR 120 (e.g., by controlling the pump (not shown) and/or the valves (not shown) within the conduit 130) such that proportion of hydrogen in the air within the HCR 120 ranges between 4% and 75%. Controller 150 may control the predetermined pressure value of hydrogen within HCR 120 (e.g., as described above) by, for example, controlling the operation of the compressor (not shown).

Controller 150 can control the expansion of hydrogen within HCR 120 (e.g., by controlling the at least one ignition element 140). In various embodiments, controller 150 is configured to determine the rotation speed of spinner 102a and/or to prevent the providing of hydrogen into HCR 120 when the rotation speed is below a predetermined value of revolutions per minute (RPM). The prevention of hydrogen providing can include terminating the delivery of hydrogen through conduit 130, for example, by deactivating the pump (not shown) and/or closing the valves (not shown) within conduit 130, and/or by deactivation the at least one ignition element 140.

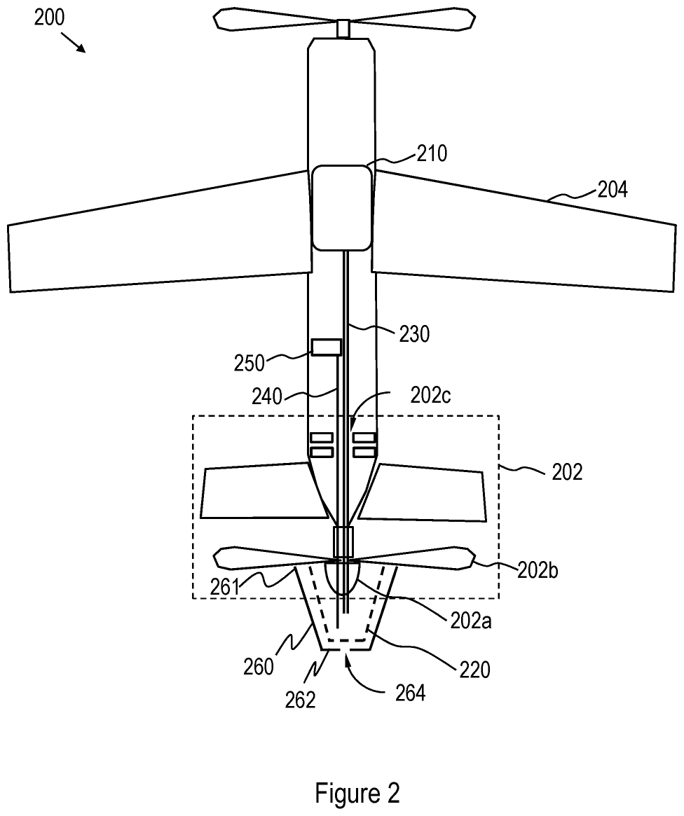

Reference is now made to FIG. 2, which schematically illustrates an airborne vehicle 200 including at least one hydrogen releasing element 210 and/or adapted for increasing a thrust by a controlled combustion of hydrogen, according to some embodiments of the invention.

Airborne vehicle 200 can include at least one hydrogen releasing element 210. In various embodiments, the at least one hydrogen releasing element 210 that may be, or may include a metal-air cell and/or open-ended fuel cell. Airborne vehicle 200 may include a hydrogen combustion region (HCR) 220 that may be positioned adjacent to a spinner 202a of propeller 202b at a rear portion of an engine 202 of the airborne vehicle 200 (e.g., as described above with respect to FIG. 1). Airborne vehicle 200 may include conduit 230 that can connect the at least one hydrogen releasing element 210 and HCR 220 and/or can deliver hydrogen released by the at least one hydrogen releasing element 210 to HCR 220 (e.g., as described above with respect to FIG. 1).

Airborne vehicle 200 may include at least one ignition element 240 that may be positioned within HCR 220 and/or can inflame the hydrogen within HCR 240 by, for example, generating an ignition spark (e.g., as described above with respect to FIG. 1). Airborne vehicle 200 may include controller 250 adapted to control the delivery of hydrogen from the at least one hydrogen releasing unit 210 to HCR 220 and/or control the inflation of hydrogen within HCR 220 (e.g., as described above with respect to FIG. 1).

In various embodiments, the at least one hydrogen releasing element 210, hydrogen combustion region 220, conduit 230, the at least one ignition element 240 and/or controller 250 are identical to the at least one hydrogen releasing element 110, hydrogen combustion region 120, conduit 130, the at least one ignition element 140 and/or controller 150 as described above with respect to FIG. 1.

Airborne vehicle 200 may include a housing 260 that can at least partly surround HCR 220 and/or can have a first end 261 and a second end 262. Housing 260 can have a tapered shape in a longitudinal direction along the housing, where a diameter of the first end 261 is greater than a diameter of the second end 262. The first end 261 of the housing 260 can be positioned adjacent to the spinner 202a of the engine 202 (e.g., as shown in FIG. 2).

In various embodiments, airborne vehicle 200 includes a second conduit (not shown), a second pump (not shown) and/or a second compressor (not shown) that can deliver oxygen to HCR 220 (e.g., that can be surrounded by the housing 260) such that proportion of hydrogen within the HCR 220 can range between 4% and 75%. The at least one ignition element 240 can inflame hydrogen within the HCR 240 and/or within housing 260 by, for example, generating an ignition spark (e.g., as described above with respect to FIG. 1). In various embodiments, the ignition spark is generated due to electrostatic effect induced by, for example, rotational motion of the spinner 202a relative to a shaft of the propeller 202b and/or by a rotational motion of the spinner 202a relative to housing 260 and/or by piezoelectric unit.

Housing 260 can include an opening 264 positioned, for example, at the second end 262. The opening 264 can enable escaping of burning products (e.g., generated due to burning of hydrogen) from HCR 220 and/or housing 260 thereby providing additional thrust to the airborne vehicle.

According to alternative and/or additional embodiments spinner 202a may be formed to act as a hydrogen combustion chamber instead of housing 260, in which case spinner 202a may be formed with an opening at its rear end, thereby enabling its operation as described above with respect to housing 260, when hydrogen is provided into its inner space and ignition is provided in a timed manner, as described above.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A vehicle comprising:
at least one hydrogen releasing element coupled to a body of the vehicle;
a hydrogen combustion region positioned adjacent to a predetermined portion of the vehicle body;
a conduit connecting the at least one hydrogen releasing element and the hydrogen combustion region, the conduit to deliver hydrogen released by the at least one hydrogen releasing element to the hydrogen combustion region;
at least one ignition element positioned within the hydrogen combustion region, the at least one ignition element to inflame hydrogen within the hydrogen combustion region; and
a controller to control the delivery of hydrogen through the conduit and to control the at least one ignition element.

2. An airborne vehicle comprising:
at least one hydrogen releasing element coupled to a body of the airborne vehicle;
a hydrogen combustion region positioned adjacent to a predetermined portion of the airborne vehicle body;
a conduit connecting the at least one hydrogen releasing element and the hydrogen combustion region, the conduit to deliver hydrogen released by the at least one hydrogen releasing element to the hydrogen combustion region;
at least one ignition element positioned within the hydrogen combustion region, the at least one ignition element to inflame hydrogen within the hydrogen combustion region; and
a controller to control the delivery of hydrogen through the conduit and to control the at least one ignition element.

3. The airborne vehicle of claim 2, wherein the at least one hydrogen releasing element comprises at least one of: a hydrogen tank, a metal-air cell, an open-ended fuel cell or any combination thereof.

4. The airborne vehicle of claim 2, wherein hydrogen is released from the at least one hydrogen releasing element at a pressure of substantially 1 atmosphere.

5. The airborne vehicle of claim 4, further comprising a compressor positioned along the conduit, the compressor to pressurize hydrogen released by the at least one releasing element to a predetermined pressure value.

6. The airborne vehicle of claim 2, wherein the hydrogen combustion region comprises oxygen and wherein the proportion of hydrogen to air within the hydrogen combustion region ranges between 4% and 75%.

7. The airborne vehicle of claim 2, wherein the airborne vehicle body comprises a spinner of a propeller positioned at a rear portion of an engine of the airborne vehicle.

8. The airborne vehicle of claim 7, wherein hydrogen is pressurized within the hydrogen combustion region due to a rotational motion of the spinner.

9. The airborne vehicle of claim 7, wherein the controller further to determine a rotation speed of the spinner and to prevent the inflation of hydrogen within the hydrogen combustion region when the determined rotation speed is below a predetermined value of revolutions per minute (RPM).

10. The airborne vehicle of claim 7, further comprising a housing to surround the hydrogen combustion region, the housing having a first end and a second end, wherein the first end is positioned adjacent to the spinner.

11. The airborne vehicle of claim 10, wherein the housing having a tapered shape in a longitudinal direction along the housing, and wherein a diameter of the first end is greater than a diameter of the second end.

12. The airborne vehicle of claim 10, further comprising a second conduit to deliver oxygen into the hydrogen combustion region such that a partial portion of hydrogen within the hydrogen combustion region ranges between 4% and 75%

13. The airborne vehicle of claim 10, wherein the ignition element comprises ignition wires introduced into the hydrogen combustion region through at least one of: a shaft of the propeller, a substantially hollow shaft of the engine, a shaft of the propeller, a shaft of the spinner or any combination thereof.

14. The airborne vehicle of claim 10, wherein an ignition spark is generated within the hydrogen combustion region due to electrostatic effect induced by at least one of: a rotational motion of the spinner relative to a shaft of the propeller, a rotational motion of the spinner relative to the housing or any combination thereof.

15. The airborne vehicle of claim 10, wherein the housing comprises at least one opening positioned at the second end of the housing, the at least one opening to enable escaping of burning products from the housing thereby providing additional thrust to the airborne vehicle.

16. The airborne vehicle of claim 10, wherein the engine is an electric engine and wherein the conduit is introduced through a substantially hollow shaft of the engine.
